(19) United States
(12) Patent Application Publication
(10) Pub. No.: US 2026/0331902 A1
(43) Pub. Date: Oct. 22, 2026

(54) DIAGNOSIS METHOD OF A CHARGING UNIT, A DIAGNOSIS DEVICE, AND A VEHICLE INCLUDING THE SAME

(71) Applicants: HYUNDAI MOTOR COMPANY, Seoul (KR); KIA CORPORATION, Seoul (KR)

(72) Inventor: Hyeon Jun Kim, Hwaseong-si (KR)

(73) Assignees: HYUNDAI MOTOR COMPANY, Seoul (KR); KIA CORPORATION, Seoul (KR)

(21) Appl. No.: 19/402,525

(22) Filed: Nov. 26, 2025

(30) Foreign Application Priority Data
Apr. 16, 2025 (KR) 10-2025-0049372

(51) Int. Cl. H02H 5/04; G01K 3/10; G06F 1/20

(52) U.S. Cl. CPC H02H 5/04; G01K 3/10; G06F 1/206

(57) ABSTRACT

A diagnosis method of a charging unit, a diagnosis device, and a vehicle including the same are disclosed. The diagnosis method may include obtaining time-series temperature data of the charging unit; extracting unit data for one section including a plurality of periods from temperature data, wherein the unit data is generated for each period of the plurality of periods; inputting the unit data to a trained abnormality detection model; encoding the input unit data; decoding the encoded unit data; calculating an error between the input unit data and the decoded data; determining that a state of the charging unit is an abnormal state when the error exceeds a threshold value; and performing a protection operation on the charging unit. The charging unit may be re-engaged as a protection operation for the charging unit.

### CROSS-REFERENCE TO RELATED APPLICATION

This application claims the priority to and the benefit of Korean Patent Application No. 10-2025-0049372, filed on Apr. 16, 2025, the entire contents of which are incorporated herein by reference.

### TECHNICAL FIELD

The present disclosure relates to a diagnosis method of a charging unit, a diagnosis device, and a vehicle including the same. More specifically, the present disclosure relates to a method of diagnosing a state of a charging unit based on time-series temperature data of a charging unit, a diagnosis device, which performs the diagnosis method, and a vehicle including the same.

### BACKGROUND

An electric vehicle is an eco-friendly vehicle using electricity as power, and because batteries and electric motors instead of an internal combustion engine are used in the electric vehicle, very little carbon is emitted during traveling. Accordingly, due to recent world-wide eco-friendly policies, carbon emission regulations, and the like, the supply of electric vehicles is rapidly spread.

Charging issues related to electric vehicles are very important technical issues. Lithium-ion batteries are mainly used as batteries in electric vehicles and have advantages of high energy density and long lifetime but essentially requires technologies for preventing fire caused by impact or overheating. Particularly, because rapid charging technologies for improving charging efficiency are supplied recently, technical demands related to safety and efficiency in battery charging are high.

To this end, although a technology for physically detecting a coupling state of an inlet of a battery charger has been adopted recently in order to secure safety during battery charging, there is a case in which an abnormal state of a charging unit is not detected due to mechanical tolerances and deformation, such as warpage or sagging. Accordingly, because there is a problem that a connection state of a charger is detected to be different from an actual state thereof, technologies for supplementing this are required. The subject matter described in this background section is intended to promote an understanding of the background of the disclosure and thus may include subject matter that is not already known to those of ordinary skill in the art. The statements in this section merely provide background information related to the present disclosure and may not constitute prior art.

### SUMMARY

A technical objective of the present disclosure is directed to overcoming a mechanical tolerance and physical deformation and detecting an abnormality of a battery charging unit.

A technical objective of the present disclosure is directed to providing a method of early detecting risk of fire, charging efficiency degradation, part damage, and dielectric breakdown and guiding normal fastening of a charging unit or providing a method of protecting the charging unit.

A technical objective of the present disclosure is directed to preventing a situation in which a power source of a vehicle is completely charged and enters a standby state so that a temperature sensor is not available and thus the temperature sensor does not detect an overheating phenomenon caused by incomplete fastening of a charging unit.

Technical objectives of the present disclosure are not limited to the above-described technical objectives, and the other technical objectives, which are not described above should be clearly understood by those having ordinary skill in the art belonging to the present disclosure from the following descriptions.

One aspect of the present disclosure provides a diagnosis including obtaining time-series temperature data of the charging unit. The method further includes extracting unit data for one section including a plurality of periods from temperature data, wherein the unit data is generated for each period of the plurality of periods. The method further includes inputting the unit data to a trained abnormality detection model, encoding the input unit data, decoding the encoded unit data, and calculating an error between the input unit data and the decoded data. The method further includes determining that a state of the charging unit is an abnormal state when the error exceeds a threshold value. The method further includes performing a protection operation on the charging unit.

According to the embodiment of the present disclosure, the abnormality detection model used in the diagnosis method may be trained based on a data set including a plurality of pieces of unit training data. The plurality of pieces of unit training data is extracted from time-series training data for a temperature of a training charging unit for the one section including the plurality of periods and is generated for each period.

According to the embodiment of the present disclosure, the abnormality detection model may be trained based on the data set such that each piece of input unit training data is encoded, the encoded unit training data is decoded, and an error between the input unit training data and the decoded training data is within a predetermined range.

According to the embodiment of the present disclosure, obtaining the time-series temperature data of the charging unit may include obtaining the time-series temperature data including a dynamic temperature characteristic curve graph according to time.

According to the embodiment of the present disclosure, obtaining the time-series temperature data of the charging unit may include normalizing the temperature data by reflecting a temperature of outside air and a starting temperature of the charging unit.

According to the embodiment of the present disclosure, determining that the state of the charging unit is the abnormal state may include determining that fastening of the charging unit is in an abnormal fastening state when the error exceeds the threshold value and a voltage distribution value according to the fastening of the charging unit is in a normal state.

According to the embodiment of the present disclosure, performing the protection operation may include controlling the charging unit to stop charging.

According to the embodiment of the present disclosure, performing the protection operation may include controlling the charging unit such that fastening of the charging unit is unfastened and then the charging unit is fastened again.

Another aspect of the present disclosure provides a diagnosis device including a temperature sensor configured to obtain time-series temperature data of a charging unit; a memory configured to store the temperature data, a trained abnormality detection model, and one or more commands; and a processor. The processor is configured to determine whether fastening of the charging unit is abnormal based on the temperature data. The processor is further configured to extract unit data for one section including a plurality of periods from the temperature data. The processor is further configured to generate the unit data for each period of the plurality of periods. The processor is further configured to input the unit data to the abnormality detection model, encodes the input unit data, decodes the encoded unit data, calculates an error between the input unit data and the decoded data. The processor is further configured to determines that a state of the charging unit is an abnormal state when the error exceeds a threshold value. The processor is further configured to perform a protection operation on the charging unit.

According to the embodiment of the present disclosure, the temperature data used in the diagnosis method performed by the diagnosis device may include a dynamic temperature characteristic curve graph according to time.

According to the embodiment of the present disclosure, the processor may normalize the temperature data by reflecting a temperature of outside air and a starting temperature of the charging unit before the unit data is extracted.

According to the embodiment of the present disclosure, the processor may periodically receive the time-series temperature data from the temperature sensor based on a controller area network (CAN) protocol.

According to the embodiment of the present disclosure, the abnormality detection model may be trained based on a data set including unit training data. The plurality of pieces of unit training data is extracted from time-series training data of a temperature of a training charging unit for the one section including the plurality of periods and is generated for each period.

According to the embodiment of the present disclosure, the abnormality detection model may be trained based on the data set such that each piece of input unit training data is encoded, the encoded unit training data is decoded, and an error between the decoded training data and the input unit training data is within a predetermined range.

According to the embodiment of the present disclosure, the processor may determine that the fastening of the charging unit is in an abnormal state when the error exceeds the threshold value and a voltage distribution value according to the fastening of the charging unit is in a normal state. The processor may control the protection operation to be performed.

According to the embodiment of the present disclosure, the processor may control the protection operation to be performed on the charging unit and control the charging unit to stop charging.

According to the embodiment of the present disclosure, the processor may control the protection operation to be performed on the charging unit and may control the charging unit such that the fastening of the charging unit is unfastened and then the charging unit is fastened again.

According to the embodiment of the present disclosure, the diagnosis device may further include a communication unit configured to be connected to an Internet communication network and transmit and receives data. The processor may control the protection operation to be performed on the charging unit and may control the communication unit to transmit a warning message to a user and a manager of a charging station.

Still another aspect of the present disclosure provides a vehicle including a diagnosis device. The diagnosis device includes a temperature sensor configured to obtain time-series temperature data of a charging unit; a memory configured to store the temperature data, a trained abnormality detection model, and one or more commands; and a processor. The processor is configured to determine whether fastening of the charging unit is abnormal based on the temperature data. The processor is further configured to extract unit data for one section including a plurality of periods from the temperature data. The processor is further configured to generate the unit data for each period of the plurality of periods. The processor is further configured to input the unit data to the abnormality detection model, encodes the input unit data, decodes the encoded unit data, calculates an error between the input unit data and the decoded data. The processor is further configured to determines that a state of the charging unit is an abnormal state when the error exceeds a threshold value. The processor is further configured to perform a protection operation on the charging unit. The vehicle further includes an actuator configured to perform a traveling operation. The vehicle further includes a battery configured to supply power to the actuator. The vehicle further includes a charging unit configured to charge the battery.

The above-described briefly summarized features of the present disclosure are only some aspects of the detailed description of the present disclosure and do not limit the scope of the present disclosure.

### BRIEF DESCRIPTION OF THE DRAWINGS

The above and other objects, features, and advantages of the present disclosure should become more apparent to those of ordinary skill in the art by describing embodiments thereof in detail with reference to the accompanying drawings, in which:

FIG. 1 is a schematic block diagram illustrating some components of a vehicle according to one embodiment of the present disclosure;

FIG. 2 is a flowchart illustrating a method of training an abnormality detection model used when a diagnosis device diagnoses a state of a charging unit of the vehicle;

FIG. 3 is a view for describing training data used for training of the abnormality detection model; and

FIG. 4 is a flowchart for describing a diagnosis method performed by the diagnosis device using the trained abnormality detection model.

### DETAILED DESCRIPTION

Hereinafter, various embodiments of the present disclosure are described in detail with reference to the accompanying drawings in order for those having ordinary skill in the art to easily perform the present disclosure. However, the present disclosure may be implemented in several different forms and is not limited to the embodiments described herein.

When the embodiments of the present disclosure are described, specific descriptions of the known components or functions have been omitted when they are deemed to obscure the gist of the present disclosure. In addition, parts irrelevant to the description of the present disclosure are omitted in the drawings, and similar parts are denoted by similar reference numerals.

In the present disclosure, a case, in which a first component is “connected,” “coupled,” or “bonded” to a second component, may include not only a direct connecting case but also an indirect connecting case in which a third component is present therebetween. In addition, when it is described that a first component “includes” or “comprises” a second component, another component is not excluded unless specifically described otherwise, and another component may be further included therein.

The present disclosure, terms, such as “first,” and “second,” are used herein only to distinguish one component from another component, and orders, importance, or the like between the components are not limited by the above-described terms unless specifically described. Accordingly, in the range of the present disclosure, a first component in one embodiment may be referred to as a second component in another embodiment, and similarly, a second component in one embodiment may be referred to as a first component in another embodiment.

In the present disclosure, different components are for clearly describing features thereof, and it does not mean that the components are necessarily separated from each other. In other words, a plurality of components may be integrated into one hardware unit or software unit, and one component may be divided into a plurality of hardware or software units. Accordingly, even not described additionally, the integrated or divided embodiment also falls within the scope of the present disclosure.

In the present disclosure, components, which are described in various embodiments, do not necessarily mean essential components, and some components may be optional components. Accordingly, embodiments including a subset of the components described in one embodiment fall within the scope of the present disclosure. In addition, embodiments including components added to components described in various embodiments also fall within the present disclosure.

In the present disclosure, the terms, “A or B,” “at least one of A and B,” “at least one of A or B,” “A, B, or C,” “at least one of A, B, and C,” and “at least one of A, B, C or combination thereof may each include any one or all possible combinations among items listed with the corresponding terms. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

Advantages and features of the present disclosure and methods of achieving the same should be clear with reference to the accompanying drawings and the following detailed embodiments. However, the present disclosure is not limited to the embodiments to be disclosed below but may be implemented in various different forms, and the embodiments are provided so that the present disclosure is completely implemented and provided to fully explain the scope of the present disclosure for those having ordinary skill in the art belonging to the present disclosure.

Hereinafter, a diagnosis device 300 and a diagnosis method according to one embodiment of the present disclosure for a charging unit 200 of a vehicle 1, and a method of training an abnormality detection model used therein for the charging unit 200 of the vehicle 1 is described with reference to the accompanying drawings.

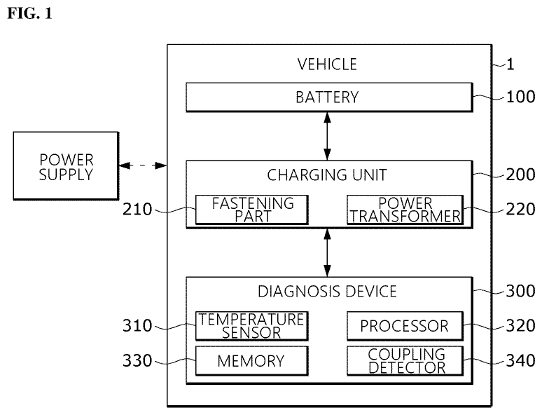

FIG. 1 is a schematic block diagram illustrating some components of the vehicle 1 according to one embodiment of the present disclosure. According to FIG. 1, the vehicle 1 may include a battery 100, the charging unit 200, the diagnosis device 300, and an actuator. The vehicle 1 may be connected to a power supply, which supplies external power through the charging unit 200, the vehicle 1 may receive the power, and the vehicle may charge the battery 100, and in this case, the diagnosis device 300 may diagnoses a state of the charging unit 200, which performs the charging.

The battery 100 may be a device, which supplies power to the vehicle 1, and when the vehicle 1 of the present disclosure is an electric vehicle, the battery may supply power to a driving motor for traveling. The battery 100 may be implemented as a lithium-ion battery, a nickel hydrogen battery, a lithium phosphate battery, or the like but is not limited thereto.

The charging unit 200 is a unit, which supplies electricity to the battery 100 of the vehicle 1 to charge the battery 100. The charging unit 200 may be connected to the power supply in order to receive the power from the outside. The charging unit 200 may include a fastening part 210 to be stably connected to the power supply and an inlet into which a plug of the power supply according to the embodiment is inserted. In this case, when the plug of the power supply is inserted into the inlet of the charging unit 200, physical fastening of the charging unit 200 and the power supply may be performed. In addition, the charging unit 200 may perform wired or wireless charging, and to this end, the charging unit 200 may be connected to the power supply. Hereinafter, the physical connection of the charging unit 200 and the power supply is called fastening.

The charging unit 200 may include a power transformer 220. The power transformer 220 performs a function of converting power supplied from the power supply to be suitable for the battery 100. According to the embodiment, the charging of the battery 100 of the vehicle 1 may be performed in an AC charging method and a DC charging method. In the AC charging, the power transformer 220 may convert AC power supplied from the power supply into DC power and then may supply the converted DC power to the battery 100, and in the DC charging, the battery 100 may receive already converted DC power from the power supply to improve a charging speed. The power transformer 220 may control a charging process by combining constant current and constant voltage charging methods in order to maximize a charging efficiency and safely charge the battery 100, and to this end, the power transformer 220 may include components such as a rectifier circuit and a converter.

In relation thereto, the power supply is a supply, which supplies power to the charging unit 200 of the vehicle 1 as described above, and may be implemented in a charging station and implemented as a home charging device, a mobile charging device, or the like. As long as a power supply supplies power to the charging unit 200 of the vehicle 1, the power supply is not limited to a type thereof. The power supply may support slow charging with AC power, quick charging with DC power, and ultraquick charging using a charger with 350 kW or more but is also only an embodiment, and the present disclosure is not limited thereto.

The diagnosis device 300 may be a device, which diagnoses a state of the charging unit 200, and may diagnose, for example, a fastening state of the charging unit 200 and the power supply. To this end, the diagnosis device 300 may include a temperature sensor 310, a processor 320, a memory 330, and a coupling detector 340.

The temperature sensor 310 may detect a temperature of the charging unit 200. The temperature sensor 310 may obtain time-series temperatures of the charging unit 200 and transmit the obtained temperatures to the processor 320. The temperature sensor 310 may communicate with the processor 320 through a communication method, such as serial peripheral interface (SPI) communication method, controller area network (CAN) communication method, or local interconnect network (LIN) communication method. Particularly, the temperature sensor 310 may periodically transmit temperature data of the charging unit 200 to the processor 320 through the CAN communication method.

The processor 320 may diagnoses a state of the charging unit 200 based on the temperature data obtained from the temperature sensor and may determine, for example, whether the charging unit 200 is abnormally fastened. According to the embodiment, the processor 320 may generate a dynamic temperature characteristic curve graph according to time based on time-series temperature data obtained from the temperature sensor 310. In other words, the diagnosis device 300 may generate a curve graph showing a correlation between a time and a temperature of the charging unit 200 based on the time-series temperature data and extract dynamic temperature characteristics of the charging unit 200 according to a change in time through the curve graph. The processor 320 may extract a plurality of pieces of unit data, which is a diagnosis reference of the charging unit 200 from the temperature data, may input the plurality of pieces of the unit data to a trained abnormality detection model, and may determine whether the charging unit 200 is abnormal. In addition, when abnormality of the charging unit 200 is detected, the processor 320 may control to perform a protection operation on the charging unit 200. A specific embodiment related thereto is described below in description of related parts.

The processor 320 may be made of one or more processing modules, and according to the embodiment, a plurality of processors may be physically separated, may be included in components of the diagnosis device 300, may be electrically connected to each other, and may perform a function of the diagnosis device 300 in conjunction with each other.

The diagnosis device 300 may include a communication unit. The communication unit may be connected to an Internet communication network and may transmit and receive data for performing a diagnosis method, and according to the embodiment, when abnormality of the charging unit 200 is detected, the processor 320 may control the communication unit to transmit a warning message related to the abnormality.

The memory 330 may store various data used when a state of the charging unit 200 is diagnosed, for example, temperature data, the trained abnormality detection model, and one or more commands for diagnosing the state of the charging unit 200. The memory 330 may load an application or read and write data according to a request from the processor 320.

The memory 330 may be implemented as at least one of non-volatile memories such as a cache, a read only memory (ROM), a programmable ROM (PROM), an erasable programmable ROM (EPROM), an electrically erasable programmable ROM (EEPROM), a flash memory, a volatile memory such as a random access memory (RAM), or storage media such as a hard disk drive (HDD) and/or compact disc ROM (CD-ROM) but is not limited thereto. According to the embodiment, the memory 330 may be implemented as one or more modules, may be physically divided and included in the temperature sensor 310, the processor 320, and the coupling detector 340, electrically connected to each other, and operated in conjunction with each other to serve a function of performing the diagnosis method on the charging unit 200.

In addition, the coupling detector 340 may be a detector for diagnosing the state of the charging unit 200 and may perform an auxiliary function for detecting whether the charging unit 200 is correctly fastened to the power supply. The coupling detector 340 may detect a fastening state through a mechanical, electrical, or electromagnetic method and, to this end, may include a voltage distribution circuit. When fastening of the charging unit 200 is incomplete or in an abnormal state, the coupling detector 340 may detect an abnormal state of a voltage distribution value and may transmit the state to the processor 320. For example, the coupling detector 340 may determine whether a charging connector is completely coupled using a physical locking structure, and the coupling detector 340 may also detect a fastening abnormality by measuring a change in contact resistance using an electrical contact detection sensor or detecting whether there is an abnormal voltage distribution value.

According to the embodiment, although the temperature sensor 310 and the coupling detector 340 may be separated from the processor 320 and provided in the charging unit 200, the temperature sensor 310 and the coupling detector 340 may be electrically connected to the processor 320 to perform a function as the diagnosis device 300 by operating in conjunction therewith.

The actuator may be an actuator, which performs a physical operation of a module included in the vehicle 1, and the actuator may include at least one module, which implements traveling operation of the vehicle 1. For example, the actuator may perform at least one traveling operation of vertical control such as acceleration and deceleration, transversal control such as steering, or gear shifting. According to the embodiment, the actuator may include an engine control unit (ECU). which controls a function of an engine. The actuator may further include a transmission control unit (TCU), which is a control module related to transmission of the vehicle 1, an electronic stability control (ESC), which electronically controls a posture of a vehicle body, and a motor driven power steering (MDPS), which is an auxiliary electronic steering device.

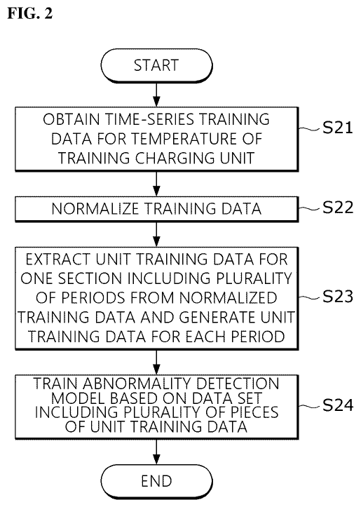

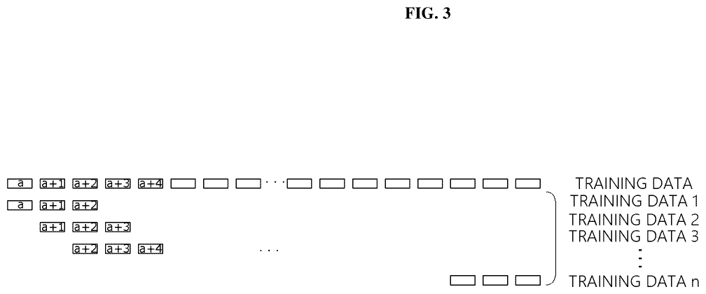

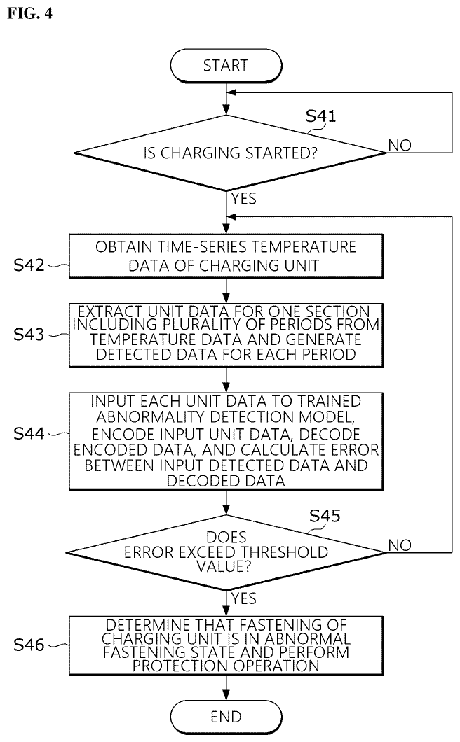

Next, the diagnosis method of the charging unit 200 of the vehicle 1 performed by the diagnosis device 300 is described with reference to FIGS. 2, 3, and 4. FIG. 2 is a flowchart illustrating a method of training the abnormality detection model used when the diagnosis device 300 diagnoses a state of the charging unit 200 of the vehicle 1. FIG. 3 is a view for describing training data used for training of the abnormality detection model. FIG. 4 is a flowchart for describing the diagnosis method performed by the diagnosis device 300 using the trained abnormality detection model.

According to FIG. 2, the processor 320 may obtain time-series training data for a temperature of a training charging unit 200 through the temperature sensor 310 (S21). In this case, the training charging unit 200 may be a unit fastened normally, and the time-series training data may include normal temperature data of the training charging unit 200.

The processor 320 may normalize the training data (S22). In other words, in order to prevent an error due to a temperature of outside air or a starting temperature, an offset is removed by normalizing the temperature data included in the training data.

The processor 320 may extract unit training data for one section including a plurality of periods from the normalized training data and generate the unit training data for each period (S23).

Referring to FIG. 3 in relation thereto, the processor 320 may obtain training data of a temperature of the training charging unit 200. In this case, the processor 320 may extract unit training data for one section including a plurality of periods from the training data. According to FIG. 3, the diagnosis device 300 extracts unit training data for one section including three periods a, a+1, and a+2, and repeatedly generates such unit training data whenever one period elapses to generate a data set including n pieces of unit training data for periods a+1, a+2, a+3/a+2, a+3, a+4/, . . .

The processor 320 may train the abnormality detection model based on the data set including a plurality of pieces of the unit training data (S24).

In this case, the processor 320 may encode each piece of the input unit training data, then may decode the encoded unit training data, and then may train the abnormality detection model such that an error between the input unit training data and the decoded training data is within a predetermined range. For example, errors of decoded values of learned temperatures are obtained, and a value distributed to correspond to 1.5σ may be set as a threshold value.

The abnormality detection model trained as described above may be stored in the memory 330.

Next, in FIG. 4, the flowchart for describing the diagnosis method using the trained abnormality detection model is shown. The processor 320 may determine whether charging starts (S41). When the charging starts (YES in S41), the processor 320 may obtain time-series temperature data of the charging unit 200 through the temperature sensor 310 (S42).

In this case, the processor 320 may periodically receive the temperature data of the charging unit 200 through CAN communication method. The processor 320 may serially obtain the temperature data of the charging unit 200 even in a standby mode state of the power supply of the vehicle 1.

According to the embodiment, the time-series temperature data may include a dynamic temperature characteristic curve graph according to time. To this end, the processor 320 may obtain the time-series temperature data of the charging unit 200 and generate the dynamic temperature characteristic curve graph based thereon. In other words, the processor 320 may generate a curve graph showing a correlation between a time and a temperature of the charging unit 200 based on the time-series temperature data and may identify dynamic temperature characteristics of the charging unit 200 according to a change in time through the curve graph.

In addition, the processor 320 may normalize the temperature data by reflecting a temperature of outside air and a starting temperature of the charging unit 200. In other words, in order to prevent an error due to the temperature of the outside air or the starting temperature, an offset is removed by normalizing the temperature data included in training data.

The processor 320 may extract unit data for one section including a plurality of periods from the temperature data and generate the unit data for each period (S43). Each piece of the unit data is generated in the same period as that of unit training data. For example, when three periods are one section for the unit training data, the temperature data of the charging unit 200 may be generated for three periods for each period.

The processor 320 may input each piece of the unit data to the trained abnormality detection model, may encode the unit data, then decode the encoded unit data, and may calculate an error between the input unit data and the decoded data (S44).

The processor 320 may determine whether the error between the input unit data and the decoded data exceeds a set threshold value (S45).

When the error between the input unit data and the decoded data exceeds the threshold value (YES S45), the processor 320 may determine that a state of the charging unit 200 is an abnormal state. For example, the diagnosis device 300 may determine that fastening of the charging unit 200 is in an abnormal fastening state and may perform a protection operation on the charging unit 200 (S46).

For example, when the unit data exceeding the threshold value is serially detected more than a set number of times, the processor 320 may determine that a state of the charging unit 200 is an abnormal state. In other words, when the unit data exceeding the threshold value is serially detected more than the set number of times and, in this case, the temperature data of the charging unit 200 has a value outside a normal range, the processor 320 may determine that the state of the charging unit 200 is the abnormal state.

In this case, the processor 320 may additionally check a voltage distribution value according to fastening of the charging unit 200 detected by the coupling detector 340, and when the unit data exceeding the threshold value is serially detected more than the number of set times and an abnormal temperature rising pattern is detected even when the normal voltage distribution value is detected, the processor 320 may determine that the charging unit 200 is in a fastening abnormal state.

When the abnormal state of the charging unit 200 is detected, the processor 320 may perform a protection operation on the charging unit 200. For example, the charging unit 200 may be controlled to stop charging of the charging unit 200. For example, the processor 320 may stop operation of the power transformer 220 of the charging unit 200 to block power supplied from the power supply. In addition, according to the embodiment, the charging unit 200 may be controlled to reduce a charging current.

In addition, the processor 320 may control the charging unit 200 such that the fastening of the charging unit 200 is unfastened and then the charging unit 200 is fastened again. For example, the processor 320 may try to normalize fastening of the charging unit 200 by controlling the charging unit 200 such that the fastening part 210 of the charging unit 200 physically releases the fastening and then fastens the charging unit 200 again.

In addition, the processor 320 may transmit a warning message for an abnormal state of the charging unit 200 to a user of the vehicle 1 such as an owner of the vehicle and a manager of the charging station through the communication unit. In addition, the processor 320 may control a controller such as the Communication Control Unit (CCU) and the TCU of the vehicle 1 to be woken up and output a warning message.

Although it has been described above that the training of the abnormality detection model and the diagnosis of an abnormal state of the charging unit 200 are performed by one diagnosis device 30, this is for the sake of convenience in the description, and as the trained abnormality detection model is stored in the memory 330, the training of the abnormality detection model and the diagnosis of the abnormal state of the charging unit 200 may be performed by different diagnosis devices 300.

According to the present disclosure, the diagnosis device 300 can overcome a mechanical tolerance or physical deformation due to stress and can detect an abnormal state of the charging unit 200. Particularly, a situation in which a contact resistance increases or a spark or arc occurs due to incomplete fastening, foreign matter, aging, or the like of the charging unit 200 may be detected by detecting an abnormal value of dynamic characteristics of a temperature of the charging unit 200, and a fire risk may be detected in advance to reduce the fire risk before a temperature rises to a risky level. In addition, even when the power supply of the vehicle 1 is in a standby state such as charging completion, an abnormal state of the charging unit 200 can be continuously checked.

According to the present disclosure, a mechanical tolerance and physical deformation can be overcome, and an abnormality of a battery charging unit can be detected.

According to the present disclosure, a method of early detecting risk of fire, charging efficiency degradation, part damage, and dielectric breakdown and guiding normal fastening of a charging unit or providing a method of protecting the charging unit can be provided.

According to the present disclosure, a situation in which a power source of a vehicle is completely charged and enters a standby state so that a temperature sensor is not available and thus the temperature sensor does not detect an overheating phenomenon caused by incomplete fastening of a charging unit can be prevented.

Effects which can be achieved from the present disclosure are not limited to the above-described effects, and the other effects, which are not described above, should be clearly understood by those having ordinary skill in the art belonging to the present disclosure from the following descriptions.

The above-described illustrative methods of the present disclosure are described as a series of operations for clearness of the description but are not to limit the order that the operations are performed, and the operations may be performed at the same time or according to different orders as needed. In order to implement the methods according to the present disclosure, other operations may be additionally added to the illustrative operations, some operations may be eliminated, and the other operations may be included therein. Alternatively, some operations may be eliminated, and other separate operations may be included therein.

Various embodiments of the present disclosure do not list all possible combinations and are intended to describe representative aspects of the present disclosure, and description provided in various embodiments may be applied independently, or combinations of two or more thereof may be applied.

In addition, various embodiments of the present disclosure may be implemented using hardware, firmware, software, combinations thereof, and the like. In the case of implementation using hardware, various embodiments may be implemented using one or more of application specific integrated circuits (ASICs), digital signal processors (DSPs), digital signal processing devices (DSPDs), programmable logic devices (PLDs), field programmable gate arrays (FPGAs), general processors, controllers, microcontrollers, microprocessors, and the like.

The scope of the present disclosure includes executable software or machine-executable commands (for example, operating systems, applications, firmware, and programs), which allow the operations according to the methods of various embodiments to be performed on apparatuses or computers, and non-transitory computer-readable medium in which the software, commands, or the like executable on apparatuses or computers are stored.

What is claimed is:

1. A diagnosis method comprising:
obtaining time-series temperature data of a charging unit;
extracting unit data for one section including a plurality of periods from temperature data, wherein the unit data is generated for each period of the plurality of periods;
inputting the unit data to a trained abnormality detection model;
encoding the input unit data;
decoding the encoded unit data;
calculating an error between the input unit data and the decoded data;
determining that a state of the charging unit is an abnormal state when the error exceeds a threshold value; and
performing a protection operation on the charging unit.

2. The diagnosis method of claim 1, wherein the abnormality detection model is trained based on a data set including a plurality of pieces of unit training data,
wherein the plurality of pieces of unit training data is extracted from time-series training data for a temperature of a training charging unit for the one section including the plurality of periods and is generated for each period.

3. The diagnosis method of claim 2, wherein the abnormality detection model is trained based on the data set such that each piece of input unit training data is encoded, the encoded unit training data is decoded, and an error between the input unit training data and the decoded training data is within a predetermined range.

4. The diagnosis method of claim 1, wherein obtaining the time-series temperature data of the charging unit includes obtaining the time-series temperature data including a dynamic temperature characteristic curve graph according to time.

5. The diagnosis method of claim 1, wherein obtaining the time-series temperature data of the charging unit includes normalizing the temperature data by reflecting a temperature of outside air and a starting temperature of the charging unit.

6. The diagnosis method of claim 1, wherein determining that the state of the charging unit is the abnormal state includes determining that fastening of the charging unit is in an abnormal fastening state when the error exceeds the threshold value and a voltage distribution value according to the fastening of the charging unit is in a normal state.

7. The diagnosis method of claim 1, wherein performing the protection operation includes controlling the charging unit to stop charging.

8. The diagnosis method of claim 1, wherein performing the protection operation includes controlling the charging unit such that fastening of the charging unit is unfastened and then the charging unit is fastened again.

9. A diagnosis device comprising:
a temperature sensor configured to obtain time-series temperature data of a charging unit;
a memory configured to store the temperature data, a trained abnormality detection model, and one or more commands; and
a processor configured to:
determine whether fastening of the charging unit is abnormal based on the temperature data;
extract unit data for one section including a plurality of periods from the temperature data;
generate the unit data for each period of the plurality of periods;
input the unit data to the abnormality detection model;
encode the input unit data;
decode the encoded unit data;
calculate an error between the input unit data and the decoded data;
determine that a state of the charging unit is an abnormal state when the error exceeds a threshold value; and
perform a protection operation on the charging unit.

10. The diagnosis device of claim 9, wherein the temperature data includes a dynamic temperature characteristic curve graph according to time.

11. The diagnosis device of claim 9, wherein the processor is further configured to normalize the temperature data by reflecting a temperature of outside air and a starting temperature of the charging unit before the unit data is extracted.

12. The diagnosis device of claim 9, wherein the processor is further configured to periodically receive the time-series temperature data from the temperature sensor based on a controller area network (CAN) protocol.

13. The diagnosis device of claim 9, wherein the abnormality detection model is trained based on a data set including unit training data,
wherein the plurality of pieces of unit training data is extracted from time-series training data for a temperature of a training charging unit for the one section including the plurality of periods and is generated for each period.

14. The diagnosis device of claim 13, wherein the abnormality detection model is trained based on the data set such that each piece of input unit training data is encoded, the encoded unit training data is decoded, and an error between the decoded training data and the input unit training data is within a predetermined range.

15. The diagnosis device of claim 9, wherein the processor is further configured to:
determine that the fastening of the charging unit is in an abnormal state when the error exceeds the threshold value and a voltage distribution value according to the fastening of the charging unit is in a normal state; and
control the protection operation to be performed.

16. The diagnosis device of claim 9, wherein the processor is further configured to control the protection operation to be performed on the charging unit and controls the charging unit to stop charging.

17. The diagnosis device of claim 9, wherein the processor is further configured to:
control the protection operation to be performed on the charging unit; and
control the charging unit such that the fastening of the charging unit is unfastened and then the charging unit is fastened again.

18. The diagnosis device of claim 9, further comprising:
a communication unit configured to be connected to an Internet communication network and transmit and receive data,
wherein the processor is further configured to:
control the protection operation to be performed on the charging unit; and
control the communication unit to transmit a warning message to a user and a manager of a charging station.

19. A vehicle comprising:
a diagnosis device comprising:
a temperature sensor configured to obtain time-series temperature data of a charging unit;
a memory configured to store the temperature data, a trained abnormality detection model, and one or more commands; and
a processor configured to:
determine whether fastening of the charging unit is abnormal based on the temperature data;
extract unit data for one section including a plurality of periods from the temperature data;
generate the unit data for each period;
input each piece of the unit data to the abnormality detection model;
encode the input unit data;
decode the encoded unit data;
calculate an error between the input unit data and the decoded data;
determine that a state of the charging unit is an abnormal state when the error exceeds a threshold value; and
perform a protection operation on the charging unit;
an actuator configured to perform a traveling operation;
a battery configured to supply power to the actuator; and
a charging unit configured to charge the battery.
